(19) United States
(12) Patent Application Publication
(10) Pub. No.: US 2026/0330149 A1
(43) Pub. Date: Oct. 22, 2026

(54) HYBRID PREDICTIVE AND GENERATIVE ARTIFICIAL INTELLIGENCE DECISION LOGIC WITH DYNAMIC CONTEXT ENRICHMENT AND REFINEMENT FOR ORCHESTRATING AN AUTONOMOUS WORKFLOW

(71) Applicant: WESTLAKE CORPORATION, Houston, TX (US)

(72) Inventors: Jian YANG, Houston, TX (US); Michael DESSAUER, Houston, TX (US); Justin CARLIN, Houston, TX (US); Ryan NOLL, Houston, TX (US); Constantyn CHALITSIOS, Houston, TX (US)

(21) Appl. No.: 19/185,811

(22) Filed: Apr. 22, 2025

(51) Int. Cl. G06F 40/40; G06F 40/284; G06N 3/0475; G06N 3/09

(52) U.S. Cl. CPC G06F 40/40; G06F 40/284; G06N 3/0475; G06N 3/09

(57) ABSTRACT

Embodiments of the present disclosure generally relate to methods for autonomous orchestration of a data labeling workflow. Embodiments include generating an embedding of an input string related to input data. Embodiments include selecting a set of candidate labels from a plurality of labels based on the embedding. Embodiments include selecting a refined set of candidate labels based on using a cross-encoder model to generate a respective joint embedding of the input string and each respective label in the set of candidate labels. Embodiments include providing natural language descriptions of the refined set of candidate labels and the input string to a language processing machine learning model. Embodiments include assigning a label to the input data based on the language processing machine learning model outputting the label in response to the natural language descriptions of the refined set of candidate labels and the input string.

### FIELD

Embodiments of the present disclosure generally relate to techniques for using a hybrid of predictive logic and generative artificial intelligence (AI) logic, with enhanced techniques for dynamic context enrichment and refinement, to orchestrate an autonomous workflow such as a data labeling workflow.

### BACKGROUND

Vast amounts of data are processed in computing systems every day. In many cases, it is useful to perform automated workflows using such data such as to make predictions based on such data. Example automated workflows may involve predicting classifications or other labels to associate with particular data items and/or to inform determinations based on such data items. Existing techniques for performing such automated workflows have various technical drawbacks. For example, conventional machine learning models such as classification models are of relatively limited utility in domain-specific applications due to lack of sufficient high quality data to capture the complete complexity in such applications, and often have low levels of confidence for certain types of input data. Language processing machine learning models such as large language models (LLMs) often have difficulty interpreting domain-specific language that frequently appears in domain-specific data, and have limited ability to consider context when there is a vast amount of data that could potentially be relevant. Even if a language processing machine learning model has the ability to process large amounts of context data, there is significant cost in computing resources associated with such processing, and technical issues such as “catastrophic forgetting” can hinder the performance of such a model. Furthermore, there is a lack of proper decision logic for assessing the confidence of outputs generated using machine learning techniques, resulting in significant amounts of manual intervention in many existing techniques.

Thus, there is a need in the art for improved techniques of performing automated workflows.

### SUMMARY

Embodiments of the present disclosure generally relate to methods for autonomous orchestration of a data labeling workflow. Unlike conventional technologies, embodiments described herein involve a hybrid approach that employs conventional classification machine learning technology and generative machine learning technology in a dynamically orchestrated and validated process by which a solution space is automatically enriched, refined, and honed and a determination is made with a high level of confidence while minimizing computing resource utilization.

In an embodiment is provided a method for autonomous orchestration of a data labeling workflow. The method may comprise: generating, using a bidirectional encoder model, a first embedding of an input string related to input data; selecting a set of candidate labels from a plurality of labels based on the first embedding; selecting a refined set of candidate labels based on using a cross-encoder model to generate a respective joint embedding of the input string and each respective label in the set of candidate labels, wherein the refined set of candidate labels includes fewer than all labels in the set of candidate labels; providing natural language descriptions of the refined set of candidate labels and the input string to a language processing machine learning model; assigning a label to the input data based on the language processing machine learning model outputting the label in response to the natural language descriptions of the refined set of candidate labels and the input string; and performing an action based on the assigning of the label to the input data.

In other embodiments, a computing system may be configured to perform any of the above methods. In some embodiments, a computing system comprises one or more processors and a memory storing instructions that, when executed using the one or more processors, cause the computing system to perform any of the methods described above and/or below. Certain embodiments include a non-transitory computer readable medium storing instructions that, when executed using one or more processors of a computing system, cause the computing system to perform any of the methods described above and/or below.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a flowchart showing selected aspects of a process for automated workflow orchestration according to at least one embodiment.

FIG. 2 is an illustration of example aspects related to predictive techniques for automated workflow orchestration according to at least one embodiment.

FIG. 3 is an illustration of example aspects related to language model based enrichment for automated workflow orchestration according to at least one embodiment.

FIG. 4 is an illustration of example aspects related to solution semantic ranking for automated workflow orchestration according to at least one embodiment.

FIG. 5 is an illustration of example aspects related to utilizing a language model as a judge for automated workflow orchestration according to at least one embodiment.

FIG. 6 is an illustration of example aspects related to selective processing for automated workflow orchestration according to at least one embodiment.

FIG. 7 is a flowchart depicting example operations related to automated workflow orchestration according to at least one embodiment.

FIG. 8 is a diagram depicting an example computing system related to automated workflow orchestration according to at least one embodiment.

### DETAILED DESCRIPTION

Embodiments described herein generally relate to techniques for automated workflow orchestration through a hybrid artificial intelligence (AI) based approach. Embodiments of the present disclosure enable the accurate, resource-efficient, and dynamic automated determination of labels such as classifications for particular data items in a way that is not possible with existing techniques. Advantageously, aspects of the present disclosure produce results that have a higher level of confidence than those produced by prior techniques while minimizing computing resource utilization.

According to certain aspects, a multi-stage process is performed in order to determine a label for a data item, such as a classification for a transaction or other type of information. A first stage may involve utilizing a predictive technique such as a conventional machine learning model to predict a label (e.g., classification) for the data item. For example, a tree-based classification model, a neural network, or the like may be used to predict a label based on one or more features related to the data item. A confidence score may be output by such a model in connection with the predicted label, and the confidence score may be used to determine whether to automatically assign the predicted label to the data item or, alternatively, to proceed with a generative AI process (e.g., if the confidence score is below a threshold). In alternative embodiments, the predictive technique may be omitted and a generative AI process may be performed.

A second stage may involve various steps related to utilizing generative AI technology to determine a potential label for the data item. For example, a language processing machine learning model such as an LLM or other type of generative model may be used to automatically generate a natural language description of the data item, such as a description that is context-rich, human readable, and does not include domain-specific or technical jargon. For instance, such a model may be provided with the data item (e.g., one or more features of the data item) along with a prompt that instructs the model to generate a natural language description that has certain characteristics. In some aspects, the generative model may be prompted to determine an attribute of one component (e.g., feature) of the data item and to use the determined attribute to enrich the context of another component (e.g., feature) of the data item in the generated natural language description. For example, the attribute may be a scope. For instance, if the data item is a transaction and the features include a vendor, a product, and a purchaser, the prompt may instruct the generative model to determine a business scope of the vendor and use the determined business scope of the vendor to enrich the context of the product and/or purchaser in the generated natural language description.

The generated natural language description may then be used to identify candidate labels for the data item. For example, an embedding of the natural language description may be generated (e.g., using a first embedding model, such as a bidirectional encoder) and compared to embeddings associated with a set of natural language descriptions of potential labels through a semantic comparison process. In certain aspects, the natural language descriptions of the labels may be generated based on natural language descriptions of other data items that are known to be associated with the labels (e.g., based on user input), such as using a language processing machine learning model that is prompted to generate a natural language description of a given label based on natural language descriptions of data items that have been confirmed to be associated with the given label. In some aspects, a user-generated description of a label may also be used, either alone or in combination with a machine learning model generated label decryption. For example, a user generated label description may include or otherwise be based on one or more keywords associated with the label. A machine learning model generated label description may provide comprehensiveness and breadth, while a user-generated keyword based label description may provide greater depth in understanding the scope of the label. In some cases, both a machine learning model generated label description and a user generated label description may both be used for a given label (e.g., combined or separately), or one or the other may be used for the given label. In some aspects, embeddings of descriptions associated with different possible labels are stored in a vector store, and the embedding of the natural language description of the data item is compared to those stored embeddings in the vector store in order to identify one or more matches (e.g., a top n matches, where n may be configurable) based on distances (e.g., cosine similarities or other Euclidean distance measurements) between embeddings. Labels associated with embeddings that were included in the one or more best matches may be used as candidate labels. In some cases, the candidate labels may be ranked based on degrees of similarity of their corresponding embeddings to the embedding of the natural language description of the data item.

The candidate labels (which may be ranked) may then be further refined through use of a second embedding model, such as a cross-encoder. For example, the second embedding model may be a larger (e.g., having more parameters) and/or more resource-intensive model than the first embedding model. The second embedding model may be used to generate a joint embedding of the generated natural language description and each respective label in the candidate labels (e.g., each joint embedding represents a combination of the generated natural language description and one of the labels in the candidate labels). The second embedding model may output similarity measures, based on the joint embeddings, indicating (e.g., via a similarity score) how similar the generated natural language description is to each label in the candidate labels. The similarity measures may be used to identify one or more matches (e.g., a top x matches, where x may be configurable and may be less than n, which is the total number of candidate labels) based on distances (e.g., cosine similarities or other Euclidean distance measurements) between embeddings. Labels that are included in the one or more best matches may be used as refined candidate labels. In some cases, the refined candidate labels may be ranked based on degrees of similarity. The refined candidate labels may include fewer labels than the candidate labels.

The refined candidate labels (or, alternatively, the candidate labels if refined candidate labels are not determined in some embodiments) may be provided to a language processing machine learning model, which may be the same model as that used to generate the natural language description or may be a different model, along with the natural language description of the data item and a prompt instructing the language processing machine learning model to act as a judge and select a best label for the data item from the refined candidate labels (or candidate labels). The language processing machine learning model may also be prompted to output an explanation that provides reasoning for why a particular label was selected by the model. The language processing machine learning model may then output a selected label and, in some aspects, an associated explanation. In some aspects, the language processing machine learning model may also output token-level probabilities associated with the selected label, such as log probability values. Such token-level probabilities may be used to determine a confidence score for the selected label, such as based on a normalized geometry average of the token-level probability values.

In a third stage, the selected label output by the language processing machine learning model may be validated based on comparing the selected label to the predicted label from the first stage. For example, if the selected label matches the predicted label, then operations may proceed with automatically assigning the selected label to the data item with a high level of confidence. If the selected label does not match the predicted label but is in partial agreement with the predicted label, such as if the predicted label is in the list of candidate labels that leads to the selected label or the selected label and the predicted label are in a same higher-level category or otherwise are associated with one another in one or more particular ways, then operations may proceed with automatically assigning the selected label to the data item with a lower level of confidence, such as providing a notification along with the selected label indicating that the selected label should be manually reviewed.

If the selected label does not match the predicted label and does not meet any condition that would allow it to be considered in partial agreement with the predicted label, then operations may proceed to a selective processing stage where a variety of different approaches may be taken. For example, the selective processing stage may involve proceeding to a human control process (e.g., presenting the data item to a user for manual labeling, such as providing the user with the selected label as a low confidence suggestion), such as without automatically assigning the selected label to the data item. In another example, the selective processing stage may involve comparing a confidence score associated with the selected label (e.g., determined based on token-level probabilities) to a threshold and, if the confidence score exceeds the threshold, automatically assigning the selected label to the data item (e.g., with a lower level of confidence). If the confidence score does not exceed the threshold, some aspects may involve automatically assigning the predicted label to the data item (e.g., with a lower level of confidence). In yet another example, the selective processing stage may involve applying a random sampling technique to select between the selected label and the predicted label. For instance, the random sampling technique may be based on a confidence score of the predicted label, such as sampling the predicted label at a percentage corresponding to the confidence score of the predicted label. If the confidence score of the predicted label is 0.4, for example, the random sampling technique may have a 40% probability of selecting the predicted label and a 60% (e.g., 100%-40%) probability of selecting the selected label.

According to certain aspects, a multi-class classifier may be trained to choose between the predicted label, the selected label, and no label based on the confidence scores associated with the predicted label and the selected label. For example, a manually validated data set may be used as training data to train the multi-class classifier through a supervised learning process. Once trained, the multi-class classifier may accept the predicted label, the selected label, and the confidence scores associated with the predicted label and the selected label as inputs, and may output a selection of either the predicted label, the selected label, or no label. Such a multi-class classifier may be used in a variety of different circumstances, such as in all cases, in cases where the selected label does not match the predicted label, in cases where the selected label does not partially match the predicted label, in cases where the predicted label and/or the selected label have a corresponding confidence score below a threshold, and/or the like.

Once a data item is assigned a label using automated workflow orchestration techniques described herein, the label may allow the data item to be automatically processed in a computing system for a variety of purposes. For example, a label assigned to a data item may be used to automatically update a workflow of a software application, populate a variable, provide content via a user interface, recommend the data item to a particular user, categorize the data item, generate a financial prediction related to the item, generate a market-related prediction regarding the data item, perform automated procurement analysis with respect to the data item (e.g., if the data item is a record of a transaction related to one or more merchants or is a data set related to a product, service, entity, and/or the like).

Techniques described herein accomplish a variety of technical improvements. For example, while some conventional techniques for performing automated workflows may involve the use of conventional machine learning models such as classification models or neural networks, such techniques by themselves are limited in their ability to analyze domain-specific information and language, and have limited levels of confidence for domain-specific predictions. Furthermore, while some existing techniques for performing automated workflows may involve the use of language processing machine learning models such as LLMs, such techniques by themselves have limited context windows (e.g., such models can only process limited amounts of context information), do not typically perform well when input data includes domain-specific terminology, sometimes suffer from “catastrophic forgetting” issues (e.g., when a model abruptly and drastically forgets previously learned information upon learning new information), and often require large amounts of computing resources, particularly when provided with large amounts of potentially relevant context information. Such technical issues often result in the involvement of humans in orchestrating such workflows, which can involve large amounts of time and labor to manually evaluate large amounts of data, and typically requires significant amounts of domain-specific expertise.

Techniques described herein overcome these challenges through a hybrid multi-stage process that involves conventional machine learning techniques, language processing machine learning techniques, dynamic enrichment, multi-stage refinement, and honing of input data, automated validation based on comparing results of different techniques, selective processing to select an optimal label based on outputs from multiple machine learning techniques, and/or the like. By performing an initial prediction of a label for a data item using a conventional machine learning model and determining based on a confidence score output by such a model whether to proceed with further processing through a generative AI process, techniques described herein avoid the use of such a generative AI process (and associated computing resource utilization) when the conventional model produces a high confidence result, and create a reference point (the predicted label) to which an ultimate result of a generative AI process can be compared for automated validation purposes if such a generative AI process if performed. Furthermore, during a generative AI processing stage, by utilizing a language processing machine learning model to automatically generate a natural language description of a data item that is context-rich (e.g., enhancing the context of one component based on a determined attribute of another component) and relatively free of domain-specific jargon, techniques described herein allow candidate labels to be automatically identified through a semantic search in a manner that is more contextualized and accurate than would be enabled by existing techniques. Performing an iterative refinement of the solution space through the use of two different embedding models, such as a bidirectional encoder and a cross-encoder, further enhances the quality of the candidate labels that are ultimately considered by a language processing model in a manner that conserves computing resources by only utilizing a larger, more computationally intensive embedding model to further hone an initial set of candidate labels determined using a smaller, less computationally intensive embedding model. Providing such dynamically selected and refined candidate labels (instead of all potentially relevant labels and/or context information) and such a natural language description of the data item (instead of the only the underlying data item itself and/or all potentially relevant context information) to a language processing machine learning model enables the model to operate in a more resource-efficient manner (based on the reduced amount of input data) and to make a more accurate and informed determination based on being provided with a focused and enriched set of input data that is tailored to the expertise of language processing machine learning models (e.g., processing natural language rather than technical jargon and other types of input data). Validating outputs from a language processing machine learning model based on predictions from a conventional machine learning model allow for increased confidence in automatically selected labels, and limit manual review to situations where confidence is low, significantly reducing the amount of such human control. Furthermore, dynamic logic for automatically handling cases where an output from the language processing machine learning model does not match a corresponding prediction from a conventional machine learning model, such as based on confidence scores and/or random sampling, provides a robust automated system that limits the cases in which human control is requested to rare corner cases.

Thus, aspects of the present disclosure allow for orchestration of an automated workflow, such as involving data labeling, in a dynamic and resource-efficient manner that avoids unnecessary utilization of computing resources, improves accuracy and confidence of automatically determined results, and reduces instances in which manual review is required.

In particular use cases, such as automatically analyzing data for procurement purposes, techniques described herein significantly improve the efficiency and accuracy of such a process. Experimental results indicate that techniques described herein exceed typical human accuracy benchmarks by approximately 10-15%, achieve 54% task autonomy with 93.7% accuracy, and greatly enhance decision making speed when manual review is requested (e.g., based on providing the user with AI generated descriptions and reasoning).

In some aspects, autonomous orchestration of a data labeling workflow as described herein, such as applied to a large volume of data processing, may be sped up by applying parallel processing or multi-thread processing to initiate multiple computation cores to process multiple data entries simultaneously or quasi-simultaneously. For example, a multi-stage process described herein for data labeling may be performed for each of a plurality of input data items in parallel using such a parallel processing or multi-thread processing technique, further improving efficiency.

In a particular example, tests were performed using techniques described herein to process a large volume batch of records. In this example, 352,071 records were processed in a batch size of 400 threads. Test results indicated that the processing time per record was 0.31 seconds, demonstrating the scalability and efficiency of techniques described herein in a batch processing environment, and showcasing the ability of techniques described herein to process large volumes of data accurately and autonomously.

In the tests, the use of the hybrid predictive and generative technique described herein resulted in an overall accuracy of 72%, with 75% of the records being labeled autonomously with level 1 confidence, and with the level1 autonomous labeling process having an accuracy of 88%. These results demonstrate how aspects of the present disclosure provide reliable results and improved efficiency, with a large percentage of the workload being processed autonomously with a high level of accuracy.

By way of comparison, tests indicated that utilizing a predictive machine learning only approach (e.g., only a predictive model without any of the generative machine learning or hybrid aspects described herein) resulted in an overall accuracy of 76% with only 64% of the records being labeled autonomously. These results demonstrate that while the predictive machine learning only approach has a similar overall accuracy to the hybrid approach described herein, the predictive machine learning only approach has a significantly lower rate of high confidence outputs that result in autonomous labeling than the hybrid approach (64% versus 75%). Further, tests indicated that utilizing a generative machine learning only approach (e.g., only a generative model without any of the predictive machine learning or hybrid aspects described herein) resulted in an overall accuracy of only 36%. These results demonstrate that domain-specific data is crucial for using a generative model for domain specific tasks, and that the hybrid techniques described herein result in a dramatic improvement in accuracy as compared to a generative machine learning only approach. Thus, by greatly increasing the instances in which data items can be autonomously processed with a high level of accuracy as compared to existing predictive or generative techniques, aspects of the present disclosure result in multiple demonstrable technical improvements to the field of performing automated workflows, including improvements in efficiency, scalability, and accuracy.

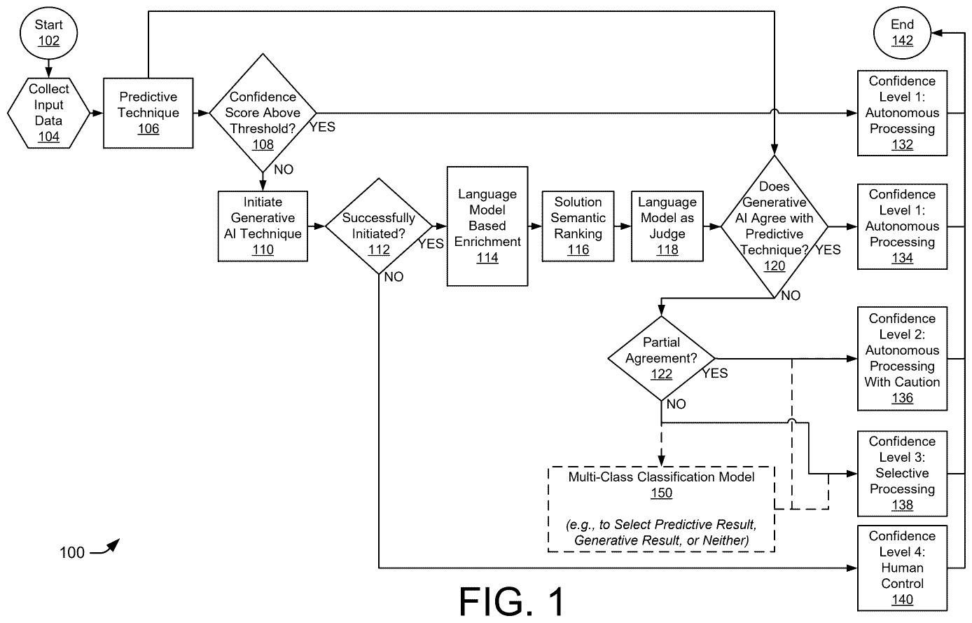

FIG. 1 is a flowchart 100 showing selected aspects of a process for automated workflow orchestration according to at least one embodiment. Embodiments and implementations of the process depicted in flowchart 100 may be combined with other embodiments described herein.

The process may begin at 102 (e.g., the start of the process), and may proceed to collecting input data 104. Collecting input data 104 may involve, for example, receiving/retrieving a data item and/or its associated information. For example, the data item may be a transaction record, a user profile, a business profile, a set of data about an entity such as a product or service, a content item (e.g., image, video, text, and/or the like), and/or the like. Information included in the input data may include one or more attributes that are part of and/or related to a data item. In some examples, the input data includes a vendor name, an asset description, manufacturing information, and/or the like (e.g., from a transaction record).

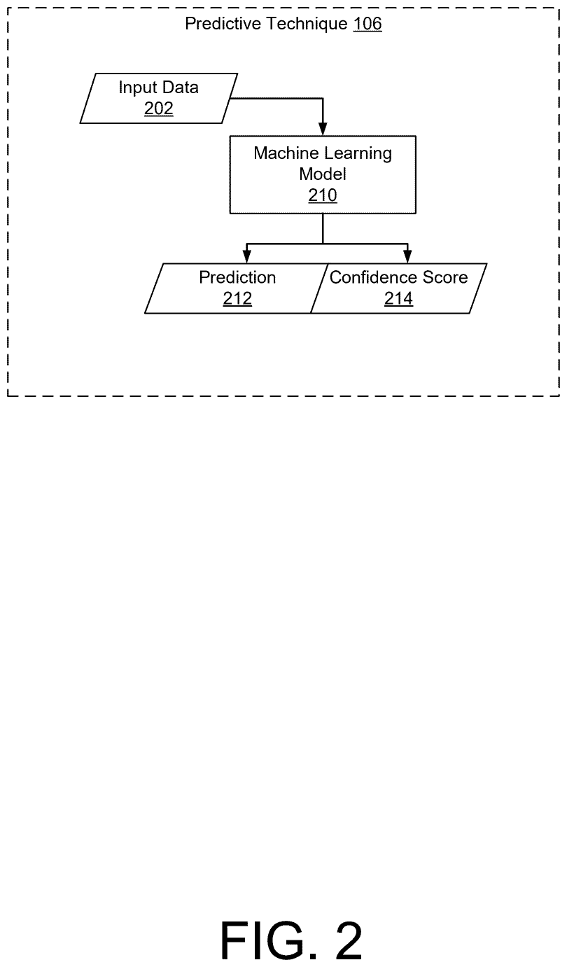

A predictive technique 106 may then be used to predict a label for the input data. Predictive technique 106 is described in more detail below with respect to FIG. 2, and may include, for example, providing inputs based on the input data to a conventional machine learning model such as a tree-based classification model or neural network and receiving a predicted label from the model in response. The model may also output a confidence score associated with the predicted label.

A determination is made at 107 of whether the confidence score associated with the predicted label (e.g., predicted using predictive technique 106) exceeds a threshold. If the confidence score exceeds the threshold, then operations may proceed at autonomous processing 132 with a high confidence level (e.g., a confidence level of 1 on a scale of 1-4, which is only included as an example). Autonomous processing 132 may involve automatically assigning the predicted label to the input data without manual review. The automatically assigned label may then allow the input data to be automatically processed in a variety of ways. If the confidence score does not exceed the threshold, then operations may proceed with initiating a generative AI technique 110. Initiating the generative AI technique 110 may involve initiating a process that includes several subsequent steps involving the use of generative machine learning technology.

A determination is made at 112 of whether the generative AI technique was successfully initiated. If the generative AI technique was not successfully initiated then operations may proceed to human control 140 with a low level of confidence (e.g., a confidence level of 4 on a scale of 1-4, which is only included as an example). Human control 140 may involve, for example, presenting a user with the input data and a set of potential labels (e.g., including the predicted label that was determined using predictive technique 106) and prompting the user to select a label for the input data. If the generative AI technique was successfully initiated then operations may proceed to language model based enrichment 114.

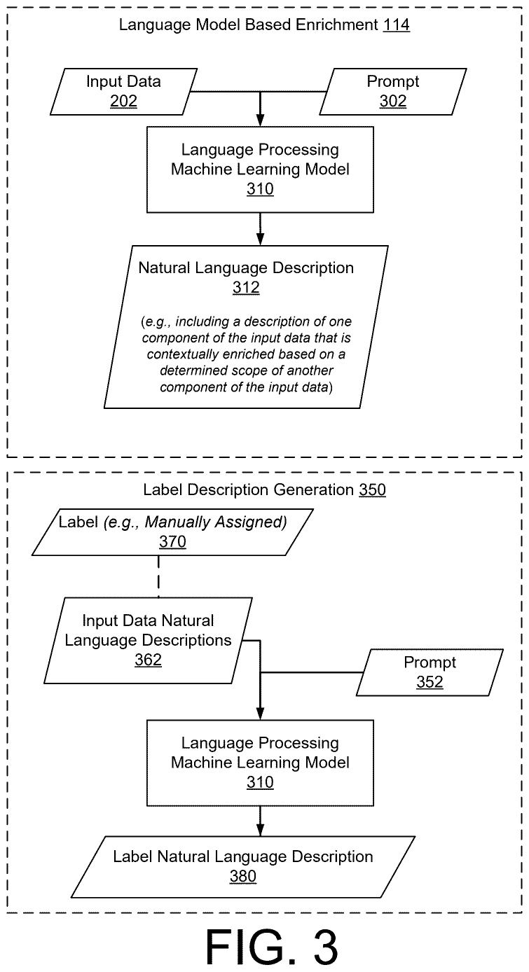

Language model based enrichment 114 is described in more detail below with respect to FIG. 3, and may involve, for example, using a language processing machine learning model such as an LLM or other type of generative model to automatically generate a natural language description of the input data, which may include relevant context. For instance, the language processing machine learning model may be provided with the input data along with a prompt that instructs the model to generate a natural language description according to one or more criteria, such as excluding or minimizing domain-specific terminology, generating the description from a particular perspective (e.g., an expert in a particular domain), using human readable language, providing additional context that does not exist in original description, and/or the like. In one example, the prompt may instruct the model to determine an attribute of one component of the input data and use the determined attribute to enrich the context of another component of the input data, such as including the enriched context for the other component of the input data in the generated natural language description. Solution semantic ranking 116 may then be performed based on the generated natural language description.

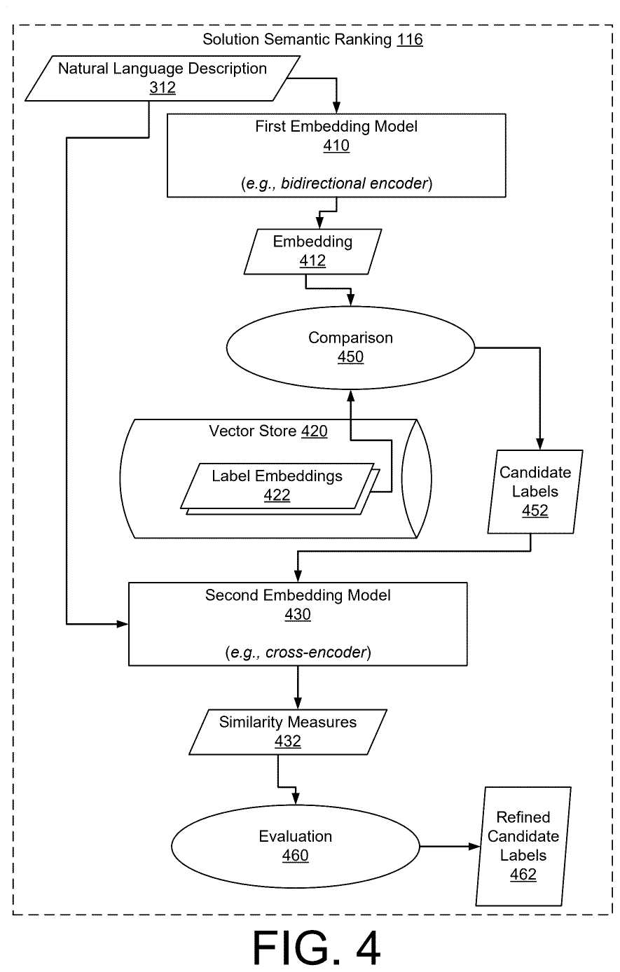

Solution semantic ranking 116 is described in more detail below with respect to FIG. 4, and may include, for example, generating an embedding of the natural language description of the input data using a first embedding model (e.g., a bidirectional encoder) and comparing that embedding to embeddings associated with a set of labels (e.g., embeddings generated using the first embedding model) in order to identify candidate labels (e.g., which may include one or more labels that are associated with embeddings that are determined to be similar to the embedding of the natural language description of the input data, such as based on cosine similarity). The embeddings associated with the labels may be embeddings of descriptions associated with the labels, and may be stored in a searchable data storage entity (e.g., a vector store). For instance, as described in more detail below with respect to FIG. 3, the descriptions of the labels may be generated based on natural language descriptions of other data items that are known to be associated with the labels, such as using a language processing machine learning model (e.g., the same model or a different model than that used at language model enrichment 114) that is prompted to generate a natural language description of each given label based on natural language descriptions of data items that have been confirmed to be associated with the given label (e.g., the natural language descriptions of the data items may be manually created or automatically generated, such as in the manner described with respect to language model based enrichment 114). In one example, the candidate labels include a top n matching labels (e.g., labels associated with embeddings that are determined to be most similar to or closest to the embedding of the natural language description of the input data), where n may be configurable. In some aspects, the candidate labels are further refined through the use of a second embedding model (e.g., a cross-encoder) that is larger, more complex, and/or more computationally intensive that the first embedding model. For example, the second embedding model may be used to generate a joint embedding of the natural language description of the input data and each label in the candidate labels. The second embedding model may output similarity measures based on the joint embeddings, and the similarity measures may be used to determine refined candidate labels. In one example, the refined candidate labels include a top x matching labels (e.g., labels that are determined to be most similar to or closest to the natural language description of the input data), where x may be configurable, and may be smaller than n such that the refined candidate labels includes fewer labels than the candidate labels. The process may then proceed to language model as a judge 118.

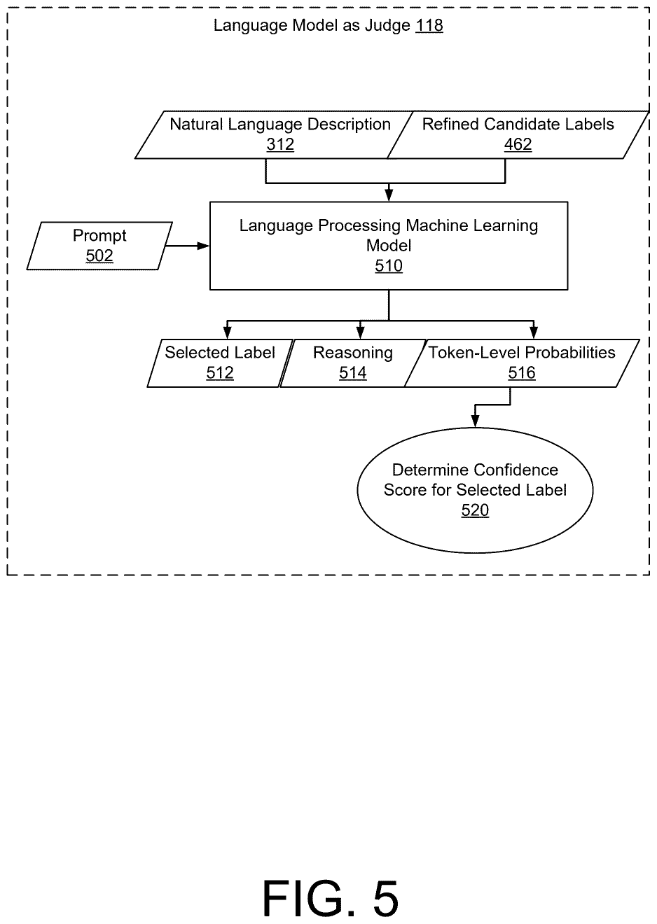

Language model as a judge 118 is described in more detail below with respect to FIG. 5, and may include, for example, providing the refined candidate labels (e.g., and/or their associated descriptions) to a language processing machine learning model along with the natural language description of the input data (e.g., and, in some aspects, the input data itself) and a prompt that instructs the model to select a label from the refined candidate labels for the input data. In some aspects, the prompt also instructs the model to output an explanation associated with the selected label, such as including reasoning for why the selected label was selected by the model. The language processing machine learning model used at language model as a judge 118 may the same as or different than the language processing machine learning model used at language model based enrichment 114. The language processing machine learning model may output a selected label based on the inputs, and may also output an explanation associated with the selected label. The language processing machine learning model may also output token-level probabilities associated with the selected label, such as log probability values, and those token-level probabilities may be used to determine a confidence score for the selected label. For example, the normalized geometry average of the token-level probabilities may be determined and used as the confidence score for the selected label.

A decision is made at 120 of whether the generative AI result (e.g., the selected label output during language model as a judge 118) agrees with (e.g., matches) the result of the predictive technique (e.g., the predicted label determined using predictive technique 106). If the results agree with one another, then operations may proceed to autonomous processing 134 with a high level of confidence (e.g., a confidence level of 1 on a scale of 1-4, which is only included as an example). Autonomous processing 134 may involve automatically assigning the predicted label to the input data without manual review. The automatically assigned label may then allow the input data to be automatically processed in a variety of ways. If the results do not agree with one another, then a determination may be made at 122 of whether the results partially agree with one another.

Partial agreement may mean, for example, that the predicted label and the selected label do not match but belong to a same higher-level category, share one or more particular attributes, are associated with one another in one or more particular ways, are semantically similar to one another, and/or the like. If the results partially agree with one another, then operations may proceed to autonomous processing with caution 136 with a relatively high level of confidence (e.g., a confidence level of 2 on a scale of 1-4, which is only included as an example). Autonomous processing with caution 136 may involve, for example, automatically associating the selected label with the input data and displaying the selected label in connection with the input data to a user with an indication that the label does not have a highest level of confidence and/or otherwise associating the selected label with an indicator that the selected label is not certain. If the results do not partially agree with one another, then operations may proceed to selective processing 138, such as with a relatively lower level of confidence (e.g., a confidence level of 3 on a scale of 1-4, which is only included as an example).

Selective processing 138 is described in more detail below with respect to FIG. 5, and may involve a variety of different approaches. For example, selective processing 138 may involve human control, such as presenting a user with the natural language description of the input data (and, in some aspects, the input data itself) and a set of potential labels (e.g., including the predicted label that was determined using predictive technique 106, the selected label that determined using language model as a judge 118, an explanation associated with the selected label, and/or the like, and, in some embodiments, a description of each label that is displayed) and prompting the user to select a label for the input data. Human control under selective processing 138 may have a relatively higher level of confidence than human control 140 because human control under selective processing 138 involves displaying the natural language description and/or selected label (and, in some aspects, the associated explanation) generated during the generative AI process while human control 140 does not involve displaying such information (e.g., because human control 140 is performed if the generative AI process is not able to be successfully initiated). In other examples, selective processing 138 may involve comparing a confidence score (e.g., based on token-level probabilities) of the selected label that was determined using language model as a judge 118 to a threshold and determining whether to automatically assign the predicted label that was determined using predictive technique 106 or the selected label that was determined using language model as a judge 118 based on whether the confidence score exceeds the threshold (e.g., assigning the selected label if the confidence score exceeds the threshold and otherwise assigning the predicted label). In yet another example, selective processing 138 may involve random sampling, such as based on the confidence score of the predicted label. For example, a random sampling technique may involve randomly sampling the predicted label at a percentage proportional to the confidence score of the predicted label, while sampling the selected label (from language model as a judge 118) at a rate proportional to 100 minus the percentage at which the predicted label is sampled.

Once a label is assigned to the input data, either at autonomous processing 132, autonomous processing 134, autonomous processing with caution 136, human control 138, or human control 140, the process may end at 142 (e.g., the end of the process).

Furthermore, in some embodiments (e.g., when there is no agreement at 120 or partial agreement at 122, and/or in other cases), a multi-class classification model 150 is used to select between the predicted label that was determined using predictive technique 106, the selected label that was determined using language model as a judge 118, or no label, such as based on confidence scores. For example, multi-class classification model 150 may be a tree-based model (e.g., random forest, gradient boosted tree, and/or the like), a support vector machine, a regression model, a neural network, and/or the like. Multi-class classification model 150 may have been trained through a supervised learning process based on manually validated data, such as including sets of predicted labels (from a predictive process) and selected labels (from a generative AI process) with corresponding confidence scores, associated with ground truth labels that are confirmed to be accurate. For example, a supervised learning process may involve providing training inputs (e.g., a predicted label from a predictive process, a selected label from a generative AI process, and corresponding confidence scores of the predicted label and the selected label) to multi-class classification model 150, receiving outputs (e.g., indicating a chosen label or no label) from multi-class classification model 150 in response to the training inputs, and iteratively adjusting parameters of multi-class classification model 150 based on comparing the predictions to labels (e.g., ground truth labels) associated with the training inputs until one or more conditions are met. The one or more conditions may involve, for example, determining whether the predictions produced by the model match the labels, optimizing a cost function, determining whether a measure of error between training iterations is not decreasing or not decreasing more than a threshold amount, and/or the like.

Multi-class classification model 150 may be used in a variety of circumstances, such as in all cases, in no cases, in cases where the selected label does not match the predicted label, in cases where the selected label does not partially match the predicted label, in cases where the predicted label and/or the selected label have a corresponding confidence score below a threshold, and/or the like. If multi-class classification model 150 is used, then an output from multi-class classification model 150 may be used to automatically assign a label to the input data (e.g., the label that is output by multi-class classification model 150), such as at autonomous processing with caution 136, or, if multi-class classification model 150 outputs an indication of no label, to proceed to selective processing 138 or human control 140. In other embodiments, the use of multi-class classification model 150 may be an example of one branch within selective processing 138.

Further processing may be performed based on an assigned label. For example, the label assigned to the input data may allow one or more automated determinations to be made, may allow content to be automatically targeted to one or more users, may allow a variable to be automatically populated, may allow a user interface to be updated, may allow an application workflow to be automatically updated, and/or the like. For example, if the input data is a transaction record and the label is a classification relating to procurement, then an automated procurement related prediction, recommendation, or determination may be made based on the label being assigned to the input data.

The process depicted and described with respect to flowchart 100 may be performed for each of a plurality of instances of input data 104 in parallel on multiple processing devices (e.g., cores) or threads, such as using a parallel processing or multi-thread processing technique.

User input confirming or rejecting a predicted or selected label may be used to re-train multi-class classification model 150. For example, if a user confirms that a label assigned to a set of input data through techniques described herein is correct, that label may be used as a ground truth label for a new training data instance that includes, as training inputs, the predicted label from the predictive process, the selected label from the generative AI process, and the corresponding confidence scores from the overall process that resulted in the label being assigned. That new training data instance may be used to-retrain multi-class classification model 150 through a supervised learning process such as that described above, thereby further improving accuracy of subsequent iterations of the automated processing technique and reducing false positives.

FIG. 2 is an illustration of example aspects related to predictive techniques for automated workflow orchestration according to at least one embodiment. For example, FIG. 2 depicts functionality related predictive technique 106 of FIG. 1. Embodiments and implementations of functionality depicted and described with respect to FIG. 2 may be combined with other embodiments described herein.

In predictive technique 106, input data 202 may be provided to a machine learning model 210, and machine learning model 210 may output a prediction 212 and a confidence score 214 in response. Input data 202 may correspond to the input data collected at collect input data 104 of FIG. 1. Machine learning model 210 may correspond to predictive technique 106 of FIG. 1. Prediction 212 may represent a predicted label for input data 202, and confidence score 214 may represent a confidence score output by machine learning model 210 in connection with prediction 212.

Machine learning model 210 may be any type of machine learning model capable of generating a prediction and associated confidence score based on input data. For example, machine learning model 210 may be a tree-based classification model, a neural network, a regression model, a support vector machine, or the like. In some aspects, machine learning model 210 may have been trained through a supervised learning process. For example, such a supervised learning process may involve providing training inputs to the model, receiving predictions from the model in response to the training inputs, and iteratively adjusting parameters of the model based on comparing the predictions to labels (e.g., ground truth labels) associated with the training inputs until one or more conditions are met. The one or more conditions may involve, for example, determining whether the predictions produced by the model match the labels, optimizing a cost function, determining whether a measure of error between training iterations is not decreasing or not decreasing more than a threshold amount, and/or the like.

Machine learning model 210 may be re-trained over time based on user feedback and/or based on results of a generative AI process. For example, once a label is confirmed for given input data based on manual review (e.g., human control 136 or 140 of FIG. 1) and/or based on high confidence autonomous processing (e.g., autonomous processing 134 of FIG. 1), then the label may be used as a ground truth label in association with the given input data in a new training data instance that is used to re-train machine learning model 210 through a supervised learning process. Such re-training may enable machine learning model 210 to improve in accuracy over time, further reducing the cases in which the generative AI process is used and thereby further improving the resource efficiency of techniques described herein.

FIG. 3 is an illustration of example aspects related to language model based enrichment for automated workflow orchestration according to at least one embodiment. For example, FIG. 3 depicts functionality related to language model based enrichment 114 of FIG. 1 as well as functionality related to label description generation 350. Embodiments and implementations of functionality depicted and described with respect to FIG. 3 may be combined with other embodiments described herein.

In language model based enrichment 114, input data 202 may be provided to a language processing machine learning model 310 along with a prompt 302, and language processing machine learning model 310 may output a natural language description 312 in response. Input data 202 may correspond to the input data collected at collect input data 104 of FIG. 1. Natural language description 312 may be a description of input data 202 in human readable language that includes contextual information and excludes or minimizes domain-specific terminology that may be included in input data 202. Natural language description 312 may also include contextual information about one component of input data 202 that is generated by language processing machine learning model 310 based on an attribute of input data 202 (e.g., the attribute may be determined by language processing machine learning model 310 based on instructions in prompt 302 and/or may be based on information included in input data 202). For example, prompt 302 may include hierarchical reasoning that, first (e.g., at a lower hierarchical level), instructs language processing machine learning model 310 to generate context of a component of input data 202, such as to describe a business scope of a merchant indicated in input data 202 and, second (e.g., at a higher hierarchical level), instructs language processing machine learning model 310 to use the generated context of the component to enrich the context of one or more other components of input data 202 (e.g., a product, service, purchaser, and/or the like), or of the entire input data 202, in the generated natural language description 312. Thus, by prompting the model to perform context enrichment in a hierarchical manner, focusing first on one or more individual components and then using the determined context for those one or more individual components to enrich the context of different or broader components from the input data, techniques described herein improve the ability of the model to understand and enrich language that may otherwise be unfamiliar to the model or difficult to parse. In some aspects, natural language description 312 is a brief string, such as 1-3 sentences.

Language processing machine learning model 310 may be any type of machine learning model capable of generating a natural language description based on input data and a natural language prompt. For example, language processing machine learning model 310 may be a large language model (LLM) or other type of generative machine learning model capable of processing and generating natural language content. In some aspects, language processing machine learning model 310 may have been trained based on a large data set of natural language data to recognize patterns in such data. In certain aspects, language processing machine learning model 310 is a transformer neural network. Language processing machine learning model 310 may have been fine tuned based on domain specific natural language data that relates to a domain of input data 202. A domain generally refers to a subject, field, computing environment, purpose, or the like.

Prompt 302 may instruct language processing machine learning model 310 to generate a natural language description according to particular attributes, such as from a perspective of an expert in a particular domain, excluding or minimizing domain-specific language, being of a certain length or length range, using human readable language, not including reasoning, and/or the like. In some aspects, prompt 302 may instruct language processing machine learning model 310 to determine an attribute of one component of input data 202 and use the determined attribute to generate enriched context for a different component of input data for inclusion in natural language description 312. For example, input data 202 may relate to a transaction, the one component may be a vendor involved in the transaction, the attribute may be a business scope of the vendor, and the different component may be a product or a purchaser involved in the transaction.

In one example, prompt 302 includes the text “As an expert of procurement analysis for a chemical company, please give me a short description of business scope for a given vendor company that serves chemical manufacturing companies. The vendor company name is {company}. Your final response should be a string of the description you generated. Do not include your reasoning.”

In another example, prompt 302 includes the text “As an expert of procurement analysis for a chemical company, please give me a technical, categorical description of a line item in the procurement item sheet. The line item {product or service description} is a product or service of a vendor company {vendor description} that serves the chemical manufacturing plant {plant description}. Your final response should be a string of the description you generated. Please determine a business scope of the vendor company and use the determined business scope to contextually enrich the explanation of {product or service description} in the final response. Do not include your reasoning.”

Language processing machine learning model 310 may generate natural language description 312 according to prompt 302 based on input data 202.

Label description generation 350 generally represents a process by which a natural language description of a label 370 may be generated. For example, the label 370 may have been previously assigned to one or more data items (e.g., through manual labeling or manual confirmation of automated labeling). The data items to which label 370 has been previously assigned may be associated with input data natural language descriptions 362, such as comprising natural language descriptions of the data items that were generated by a user or through an automated process (e.g., language model based enrichment 114).

The input data natural language descriptions 362 may be provided to language processing machine learning model 310 (or to another language processing machine learning model) along with a prompt 352 that instructs the language processing machine learning model to generate a natural language description of the label that is commonly associated with each of input data natural language descriptions 362. For example, prompt 352 may instruct language processing machine learning model 310 to synthesize input data natural language descriptions 362 into a unified natural language description of label 370. In some aspects, label 370 may also be provided to language processing machine learning model 310 along with prompt 352 and input data natural language descriptions 362. Language processing machine learning model 310 may output label natural language description 380 based on the instructions in prompt 352. Subsequently, label natural language description 380 may be used as a description of label 370 for use in determining whether label 370 is a candidate label for a particular data item, such as in a future execution of solution semantic ranking 116 of FIG. 1. In some aspects, label natural language description 380 is a brief string, such as 1-3 sentences.

In some aspects, a user-generated label description 378 may be additionally or alternatively used for label 370. For example, user-generated label description 378 may include one or more keywords associated with label 370, and may be created for label 370 by a user, such as entered via a user interface. In particular aspects, user generated label description 378 may be combined with label natural language description 380, such as concatenating the two descriptions together or otherwise combining the two descriptions, to produce a label description that has both breadth (as a result of the model generated description) and depth (as a result of the user generated label description). In some aspects, label natural language description 380 may represent a combination of user generated label description 378 and a label description output by language processing machine learning model 310. In certain aspects, user generated label description 378 is provided to language processing machine learning model 310 along with prompt 352 and input data natural language descriptions 362, and language processing machine learning model 310 may generate label natural language description 380 in response.

Advantageously, label description generation 350 enables the automated generation of a natural language description of a label based on the data items known to be associated with the label. While labels themselves may not provide much textual data (e.g., the labels may be character strings or other identifiers that are not in natural language form and/or that otherwise provide little context about the labels), label description generation 350 allows a context-rich natural language description to be automatically generated for each label, thereby improving the ability of techniques described herein to accurately identify candidate labels for data items based on comparison of embeddings of natural language descriptions of the data items to embeddings of natural language descriptions of labels.

FIG. 4 is an illustration of example aspects related to solution semantic ranking for automated workflow orchestration according to at least one embodiment. For example, FIG. 4 depicts functionality related solution semantic ranking 116 of FIG. 1. Embodiments and implementations of functionality depicted and described with respect to FIG. 4 may be combined with other embodiments described herein.

In solution semantic ranking 117, natural language description 312 (e.g., which may have been generated as described above with respect to FIG. 3) may be provided to a first embedding model 410, and first embedding model 410 may output to an embedding 412 in response.

An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network or other model based on a data set, such as a plurality of features of a plurality of entities. In one example, first embedding model 410 is a bidirectional encoder model and second embedding model 430 is a cross-encoder model. A bidirectional encoder, or a bi-encoder, processes data (e.g., text) in both forward and backward directions, enabling it to understand context from both sides of a word or token, improving the model's language understanding and generation. A cross-encoder is a model (e.g., neural network) that processes a pair of inputs together and outputs a score indicating an amount of similarity between the two inputs in the input pair (e.g., unlike bidirectional encoders, which encode each input independently).

In one example, the first embedding model 410 comprises a text encoder such as a Bidirectional Encoder Representations from Transformer (BERT) model configured to generate embeddings. BERT models may involve the use of masked language modeling to determine embeddings. In a particular example, first embedding model 410 comprises a Sentence-BERT model. These are included as examples, and other techniques for generating embeddings are possible.

At comparison 450, embedding 412 is compared to label embeddings 422 from a vector store 420 in order to identify candidate labels 452. Label embeddings 422 may be embeddings (e.g., generated in a similar manner to that discussed above with respect to first embedding model 410) of descriptions or other text associated with particular labels (e.g., classifications). Vector store 420 may be a data storage entity, such as a database, and may be searchable, such as based on a semantic similarity search.

In some aspects, comparison 450 involves searching vector store 420 for one or more label embeddings 422 that are semantically similar to (e.g., within a threshold Euclidean distance of) embedding 412. Candidate labels 452 may, for example, include a top n matching embeddings from label embeddings 422 for embedding 412. For instance, the n embeddings from label embeddings 422 that have the smallest Euclidean distance from embedding 412 (e.g., where the embeddings are ranked in order of distance from embedding 412) may be identified as candidate labels 452. In some aspects, n may be a configurable value. More generally, candidate labels 452 may be the labels corresponding to embeddings from label embeddings 422 that are closest to embedding 412.

In certain aspects, second embedding model 320 may be used to further refine candidate labels 452, such as down to a smaller set of candidate labels (e.g., refined candidate labels 462). In one example, second embedding model 430 is a cross-encoder such as decoding-enhanced BERT with disentangled attention (De-BERTa) or another suitable type of cross-encoder model.

Natural language description 312 may be provided along with candidate labels 452 (e.g., descriptions or other text associated with the labels in candidate labels 452) to second embedding model 430, and second embedding model 430 may analyze natural language description 312 relative to each label in candidate labels 452 in order to determine a measure of similarity or relevance. For example, second embedding model 430 may generate a respective joint embedding representing the relationship between natural language description 312 and each respective label in candidate labels 452, and may output similarity measures 452 indicating a respective measure of similarity between natural language description 312 and each respective label in candidate labels 452 based on the generated joint embeddings. Each similarity measure in similarity measures 432 may, for example, be a numerical score that represents the similarity between natural language description 312 and one of the labels in candidate labels 452 based on a corresponding joint embedding.

At evaluation 460, similarity measures 432 may be evaluated to determine a subset of candidate labels 452, refined candidate labels 462, that includes labels that are most similar to natural language description 312. For example, the top x most similar (e.g., to natural language description 312) labels from candidate labels 452 may be selected as refined candidate labels 462 based on similarity measures 432, where x is less than n (e.g., meaning that refined candidate labels 462 may include fewer than all of the labels in candidate labels 452). In one example, candidate labels 452 includes twenty labels and refined candidate labels 462 includes ten labels.

Notably by only using second embedding model 430 to compare natural language description 312 to candidate labels 452, rather than to compare natural language description 312 to all of possible labels (e.g., all labels represented by label embeddings 422 in vector store 420), techniques described herein reduce the amount of physical computing resources required to obtain the enhanced benefits provided by second embedding model 430, which may be a larger (e.g., having more parameters), more complex, and/or more computing resource-intensive model than first embedding model 410. The stage-wise, iterative identification and refinement of a set of candidate labels described herein enables the system to provide a highly relevant and focused set of possible solutions to a language processing machine learning model, improving computing efficiency and enhancing accuracy of generated results.

FIG. 5 is an illustration of example aspects related to utilizing a language model as a judge for automated workflow orchestration according to at least one embodiment. For example, FIG. 5 depicts functionality related to language model as a judge 118 of FIG. 1. Embodiments and implementations of functionality depicted and described with respect to FIG. 5 may be combined with other embodiments described herein.

In language model as a judge 118, natural language description 312 (e.g., which may have been generated as described above with respect to FIG. 3) and refined candidate labels 462 (e.g., which may have been determined as described above with respect to FIG. 4) are provided to a language processing machine learning model 510 along with a prompt 502, and language processing machine learning model 510 may output a selected label 512 and associated reasoning 514 in response. In some embodiments, descriptions and/or other text associated with refined candidate labels 462 may be provided to language processing machine learning model 510 (e.g., in addition to or instead of the labels themselves).

Language processing machine learning model 510 may be any type of machine learning model capable of selecting a label from a set of candidate labels based on a natural language description and a natural language prompt. For example, language processing machine learning model 510 may be an LLM or other type of generative machine learning model capable of processing and generating natural language content. Language processing machine learning model 510 may be the same model as or a different model than language processing machine learning model 310 of FIG. 3. In some aspects, language processing machine learning model 510 may have been trained based on a large data set of natural language data to recognize patterns in such data. In certain aspects, language processing machine learning model 510 is a transformer neural network. Language processing machine learning model 510 may have been fine tuned based on domain specific natural language data that relates to a domain associated with natural language description 312. A domain generally refers to a subject, field, computing environment, purpose, or the like.

Prompt 502 may instruct language processing machine learning model 510 to act as a judge and select between the labels in refined candidate labels 462 as a label for a data item described by natural language description 312. Prompt 502 may also instruct language processing machine learning model 510 to output an explanation of why it selected a particular label (e.g., reasoning 514 may represent such an explanation). In certain aspects, prompt 502 may also instruct language processing machine learning model 510 to output token-level probabilities for its other output(s). In some embodiments, the data item itself is also provided to language processing machine learning model 510 and/or descriptions associated with refined candidate labels 462 are also provided to language processing machine learning model 510.

Language processing machine learning model 510 may output selected label 512 and reasoning 514 in response to the inputs. Selected label 512 may be a label included in refined candidate labels 462 that language processing machine learning model 510 determines is a best fit for natural language description 312. Reasoning 514 may include a natural language description of why selected label 512 was selected.

Language processing machine learning model 510 may also output token-level probabilities 516. For example, token-level probabilities 516 may be log probability values (e.g., logprobs, or logarithms of probability values) representing the probability of each token (e.g., in selected label 512 and/or its associated description or text) occurring based on the previous tokens in the context. Token-level probabilities 516 may be used at 520 to determine a confidence score for selected label 512, such as by determining a normalized geometric average of token-level probabilities 516 and using that normalized geometric average as the confidence score.

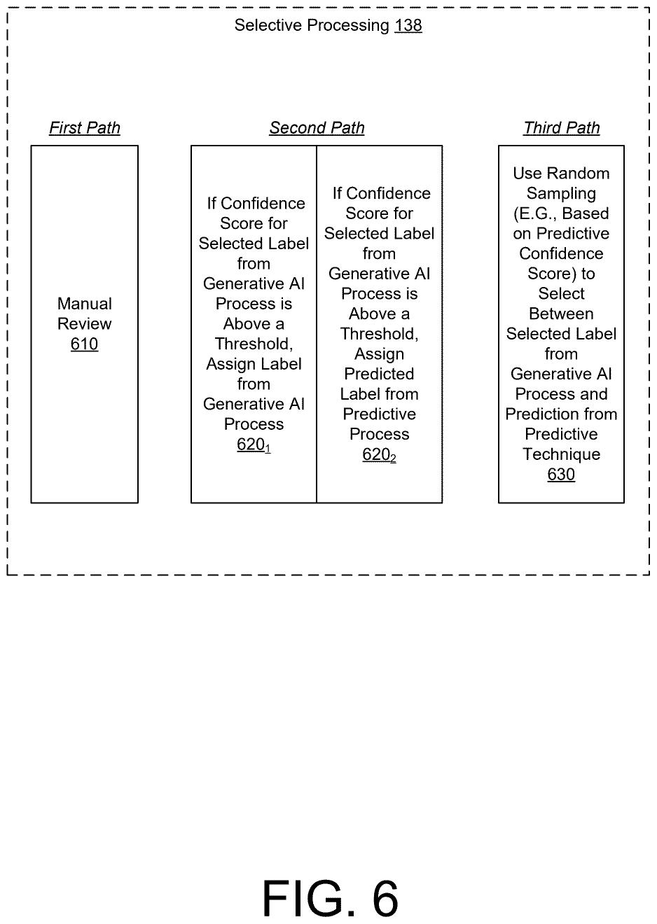

FIG. 6 is an illustration of example aspects related to selective processing 138 for automated workflow orchestration according to at least one embodiment. For example, FIG. 6 depicts functionality related to selective processing 138 of FIG. 1. Embodiments and implementations of functionality depicted and described with respect to FIG. 6 may be combined with other embodiments described herein. A first path, second path, and third path within selective processing 138 may represent different alternative functionality that may be performed at selective processing 138 (e.g., based on design or configuration).

A first path within selective processing 138 may include manual review 610. For example, manual review 610 may involve displaying one or more selected labels, predicted labels, or other possible labels, such as along with description(s), confidence score(s), and/or other relevant information, via a user interface and receiving user input via the user interface selecting a label to assign to input data. Manual review 610 may be performed in cases where automated assignment of labels is not performed, such as when a selected label output from a generative AI process does not match (or, in some cases, does not even partially match) a predicted label output from a predictive process, and/or, in some aspects, if a confidence score for the selected label (e.g., determined at 520 of FIG. 5) does not exceed a threshold. A user selection of a label at manual review 610 may result in the user-selected label being assigned to the input data.

A second path within selective processing 138 may include determining whether a confidence score for the selected label output from the generative AI process (e.g., the confidence score determined at 520 of FIG. 5 based on token-level probabilities) exceeds a threshold. If the confidence score exceeds the threshold, then the selected label from the generative AI process may be automatically assigned to the input data. If the confidence score does not exceed the threshold, then the predicted label from the predictive process may be automatically assigned to the input data (and/or manual review 610 may be performed).

A third path within selective processing 138 may include the use of a random sampling technique to selected between the selected label from the generative AI process and the predicted label from the predictive process, such as based on the confidence score for the predicted label (e.g., confidence score 214 of FIG. 2), For example, the random sampling technique may involve sampling the predicted label at a rate that is proportional to the confidence score of the predicted label, and sampling the selected label at a rate equal to one hundred minus the rate at which the predicted label is sampled. For example, if the confidence score of the predicted label is 0.3, then the random sampling technique may involve randomly selecting between the predicted label and the selected label with a 30% probability of selecting the predicted label and a 70% likelihood of selecting the selected label. In other embodiments, the confidence score of the selected label (e.g., the confidence score determined at 520 of FIG. 5 based on token-level probabilities) is used for the random sampling technique instead of the confidence score of the predicted label. For example, the selected label may be sampled at a rate proportional to the confidence score of the selected label while the predicted label may be sampled at a rate proportional to one hundred minus the rate at which the selected label is sampled. Other implementations of the random sampling technique are possible, and these are included as examples.

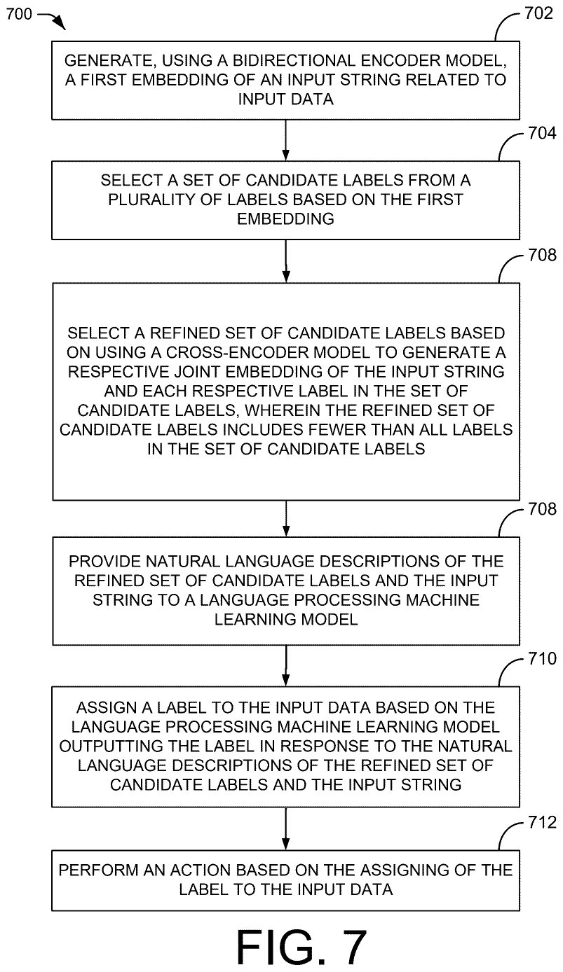

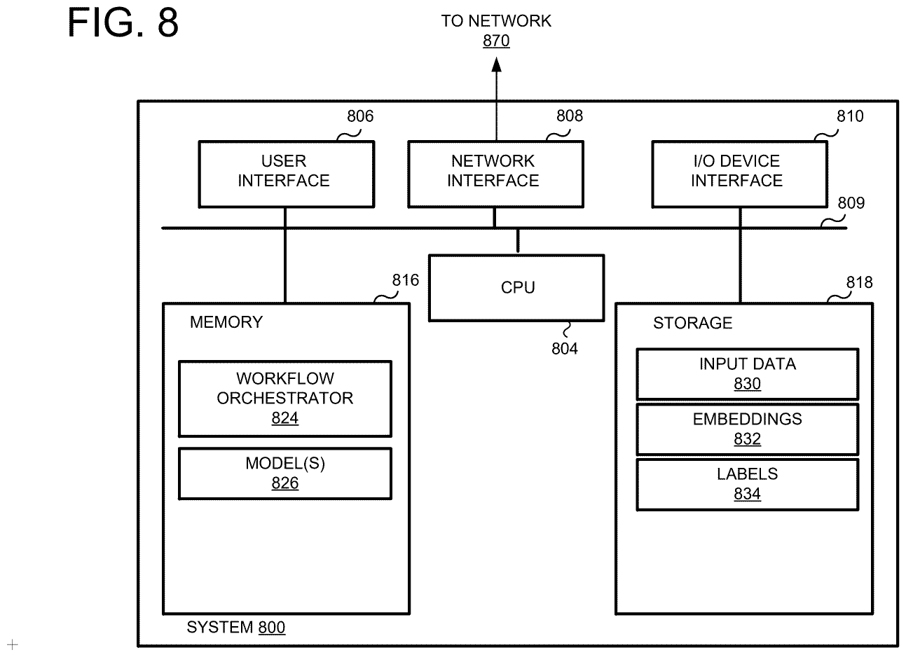

FIG. 7 is a flowchart depicting example operations 700 related to automated workflow orchestration according to at least one embodiment. For example, operations 700 may be performed by one or more components depicted and described above with respect to FIGS. 1-6 and/or by system 800 of FIG. 8.

Operations 700 may begin at 702, with generating, using a bidirectional encoder model, an embedding of an input string related to input data.

Operations 700 may continue at 704, with selecting a set of candidate labels from a plurality of labels based on the embedding.

Operations 700 may continue at 706, with selecting a refined set of candidate labels based on using a cross-encoder model to generate a respective joint embedding of the input string and each respective label in the set of candidate labels, wherein the refined set of candidate labels includes fewer than all labels in the set of candidate labels.

Operations 700 may continue at 708, with providing natural language descriptions of the refined set of candidate labels and the input string to a language processing machine learning model.

Operations 700 may continue at 710, with assigning a label to the input data based on the language processing machine learning model outputting the label in response to the natural language descriptions of the refined set of candidate labels and the input string.

Operations 700 may continue at 712, with performing an action based on the assigning of the label to the input data.

Some aspects further comprise generating a prediction based on the input data using a classification machine learning model and determining that a confidence score associated with the prediction is below a threshold, wherein the generating of the embedding, the selecting of the set of candidate labels, the selecting of the refined set of candidate labels, the providing of the natural language descriptions of the refined set of candidate labels and the input string to the language processing machine learning model, and the assigning of the label are based on the determining that the confidence score associated with the prediction is below the threshold.

In certain aspects, the assigning of the label to the input data is further based on determining that the label matches the prediction.

In some aspects, the assigning of the label to the input data is further based on determining that the label does not match the prediction and receiving manual confirmation of the label.

In certain aspects, the assigning of the label to the input data is further based on determining that the label does not match the prediction and determining that a corresponding confidence score associated with the label output by the language processing machine learning model is above a threshold.

In some aspects, the assigning of the label to the input data is further based on: determining that the label does not match the prediction; and selecting between the prediction and the label according to a random sampling technique that is based on the confidence score associated with the prediction.

In certain aspects, the assigning of the label to the input data is further based on: providing, to a multi-class classification model, a set of inputs comprising the prediction, the label, the confidence score associated with the prediction, and a corresponding confidence score associated with the label output by the language processing machine learning model; and selecting between the prediction and the label based on an output received from the multi-class classification model in response to the set of inputs.

In some aspects, the selecting of the set of candidate labels from the plurality of labels based on the embedding comprises: comparing the embedding to embeddings of descriptions of the plurality of labels; and selecting the set of candidate labels based on the comparing, wherein the set of candidate labels contains fewer than all of the plurality of labels. Certain aspects further comprise generating the descriptions of the plurality of labels by, for each respective label of the plurality of labels, prompting a generative machine learning model to generate a natural language description of the respective label based on corresponding natural language descriptions of a plurality of data items confirmed to be associated with the respective label. In some aspects, the natural language description of each respective label is further based on a user generated label description comprising one or more keywords associated with the respective label.

Certain aspects further comprise generating the input string by prompting a generative machine learning model to generate a natural language description of the input data in a manner that adds context to the input data and uses human readable natural language.

In some aspects, the prompting comprises instructing the generative machine learning model to generate the natural language description in such a manner as to contextually enrich one component of the input data based on a determined scope of a second component of the input data.

Certain aspects further comprise providing the language processing machine learning model, along with the natural language descriptions of the refined set of candidate labels and the input string, a prompt instructing the language processing machine learning model to select from among the refined set of candidate labels based on the input string.

Some aspects further comprise determining a confidence score for the label output by the language processing machine learning model based on token-level probability values output by the language processing machine learning model in connection with the label, wherein the assigning of the label is based on the confidence score.

In certain aspects, the determining of the confidence score comprises determining a normalized geometry average of the token-level probability values.

In some aspects, the performing of the action comprises one or more of: updating a workflow of a computing application; populating a variable; or displaying content via a user interface.

Certain aspects further comprise generating an additional prediction based on additional input data using a classification machine learning model, determining, based on a corresponding confidence score associated with the additional prediction exceeding a threshold, not to perform a corresponding generative artificial intelligence process for the additional input data, and assigning a corresponding label to the additional data based on the additional prediction without performing the corresponding generative artificial intelligence process.

FIG. 8 is a diagram depicting an example computing system 800 related to automated workflow orchestration according to at least one embodiment.

Although depicted as a single physical device, in embodiments, computing system 800 may be implemented using virtual device(s), and/or across a number of devices, such as in a cloud environment.

As illustrated, computing system 800 includes a central processing unit (CPU) 804, memory 816, storage 818, a network interface 808, and one or more I/O interfaces 810. In the illustrated embodiment, CPU 804 retrieves and executes programming instructions stored in memory 816, as well as stores and retrieves application data residing in storage 818. CPU 804 is generally representative of a single CPU and/or GPU, multiple CPUs and/or GPUs, a single CPU and/or GPU having multiple processing cores, and the like. Memory 816 is generally included to be representative of a random-access memory. Storage 818 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output (I/O) devices (such as keyboards, monitors, etc.) can be connected via the I/O interface(s) 810. Further, via network interface 808, computing system 800 can be communicatively coupled with one or more other devices and components. In certain embodiments, computing system 800 is communicatively coupled with other devices via a network 870, which may include the Internet, local network(s), and the like. The network may include wired connections, wireless connections, or a combination of wired and wireless connections. As illustrated, CPU 804, memory 816, storage 818, network interface(s) 808, and I/O interface(s) 810 are communicatively coupled by one or more interconnects 809.

In the illustrated embodiment, memory 816 includes a workflow orchestrator 824, which may perform functionality described above with respect to FIGS. 1-7. Memory 816 further includes one or more models 826, which may include machine learning model 210 of FIG. 2, language processing machine learning model 310 of FIG. 3, first embedding model 410 and/or second embedding model 430 of FIG. 4, and/or language processing machine learning model 510 of FIG. 5.

In the illustrated embodiment, storage 818 includes input data 830, which may include input data 202 of FIG. 2. Storage 818 further includes embeddings 832, which may include embedding 412 and/or label embeddings 422 of FIG. 4 (and/or one or more joint embeddings generated by second embedding model 430 of FIG. 3). Storage 818 further includes labels 834, which may include candidate labels 452 and/or refined candidate labels 462 of FIG. 4 and/or selected label 512 of FIG. 5.

As is apparent from the foregoing general description and the specific aspects, while forms of the aspects have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method. or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2. 5, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “an epoxy resin” includes aspects comprising one, two, or more epoxy resins, unless specified to the contrary or the context clearly indicates only one epoxy resin is included.

While the foregoing is directed to aspects of the present disclosure, other and further aspects of the disclosure may be devised without departing from the basic scope thereof, and the scope thereof is determined by the claims that follow.

What is claimed is:

1. A method for autonomous orchestration of a data labeling workflow, comprising:
generating, using a bidirectional encoder model, an embedding of an input string related to input data;
selecting a set of candidate labels from a plurality of labels based on the embedding;
selecting a refined set of candidate labels based on using a cross-encoder model to generate a respective joint embedding of the input string and each respective label in the set of candidate labels, wherein the refined set of candidate labels includes fewer than all labels in the set of candidate labels;
providing natural language descriptions of the refined set of candidate labels and the input string to a language processing machine learning model;
assigning a label to the input data based on the language processing machine learning model outputting the label in response to the natural language descriptions of the refined set of candidate labels and the input string; and
performing an action based on the assigning of the label to the input data.

2. The method of claim 1, further comprising:
generating a prediction based on the input data using a classification machine learning model; and
determining that a confidence score associated with the prediction is below a threshold, wherein the generating of the embedding, the selecting of the set of candidate labels, the selecting of the refined set of candidate labels, the providing of the natural language descriptions of the refined set of candidate labels and the input string to the language processing machine learning model, and the assigning of the label are based on the determining that the confidence score associated with the prediction is below the threshold.

3. The method of claim 2, wherein the assigning of the label to the input data is further based on determining that the label matches the prediction.

4. The method of claim 2, wherein the assigning of the label to the input data is further based on determining that the label does not match the prediction and receiving manual confirmation of the label.

5. The method of claim 2, wherein the assigning of the label to the input data is further based on determining that the label does not match the prediction and determining that a corresponding confidence score associated with the label output by the language processing machine learning model is above a threshold.

6. The method of claim 2, wherein the assigning of the label to the input data is further based on:
determining that the label does not match the prediction; and
selecting between the prediction and the label according to a random sampling technique that is based on the confidence score associated with the prediction.

7. The method of claim 2, wherein the assigning of the label to the input data is further based on:
providing, to a multi-class classification model, a set of inputs comprising the prediction, the label, the confidence score associated with the prediction, and a corresponding confidence score associated with the label output by the language processing machine learning model; and
selecting between the prediction and the label based on an output received from the multi-class classification model in response to the set of inputs.

8. The method of claim 1, wherein the selecting of the set of candidate labels from the plurality of labels based on the embedding comprises:
comparing the embedding to embeddings of descriptions of the plurality of labels; and
selecting the set of candidate labels based on the comparing, wherein the set of candidate labels contains fewer than all of the plurality of labels.

9. The method of claim 8, further comprising generating the descriptions of the plurality of labels by, for each respective label of the plurality of labels, prompting a generative machine learning model to generate a natural language description of the respective label based on corresponding natural language descriptions of a plurality of data items confirmed to be associated with the respective label.

10. The method of claim 9, wherein the natural language description of each respective label is further based on a user generated label description comprising one or more keywords associated with the respective label.

11. The method of claim 1, further comprising generating the input string by prompting a generative machine learning model to generate a natural language description of the input data in a manner that adds context to the input data and uses human readable natural language.

12. The method of claim 11, wherein the prompting comprises instructing the generative machine learning model to generate the natural language description in such a manner as to contextually enrich one component of the input data based on a determined scope of a second component of the input data.

13. The method of claim 12, further comprising providing the language processing machine learning model, along with the natural language descriptions of the refined set of candidate labels and the input string, a prompt instructing the language processing machine learning model to select from among the refined set of candidate labels based on the input string.

14. The method of claim 1, further comprising determining a confidence score for the label output by the language processing machine learning model based on token-level probability values output by the language processing machine learning model in connection with the label, wherein the assigning of the label is based on the confidence score.

15. The method of claim 14, wherein the determining of the confidence score comprises determining a normalized geometry average of the token-level probability values.

16. The method of claim 1, wherein the performing of the action comprises one or more of:
updating a workflow of a computing application;
populating a variable; or
displaying content via a user interface.

17. The method of claim 1, further comprising:
generating an additional prediction based on additional input data using a classification machine learning model;
determining, based on a corresponding confidence score associated with the additional prediction exceeding a threshold, not to perform a corresponding generative artificial intelligence process for the additional input data; and
assigning a corresponding label to the additional data based on the additional prediction without performing the corresponding generative artificial intelligence process.

18. A system for autonomous orchestration of a data labeling workflow, comprising:
one or more processors; and
a memory comprising instructions that, when executed by the one or more processors, cause the system to:
generate, using a bidirectional encoder model, an embedding of an input string related to input data;
select a set of candidate labels from a plurality of labels based on the embedding;
select a refined set of candidate labels based on using a cross-encoder model to generate a respective joint embedding of the input string and each respective label in the set of candidate labels, wherein the refined set of candidate labels includes fewer than all labels in the set of candidate labels;
provide natural language descriptions of the refined set of candidate labels and the input string to a language processing machine learning model;
assign a label to the input data based on the language processing machine learning model outputting the label in response to the natural language descriptions of the refined set of candidate labels and the input string; and
perform an action based on the assigning of the label to the input data.

19. The system of claim 18, wherein the instructions, when executed by the one or more processors, further cause the system to:
generate a prediction based on the input data using a classification machine learning model; and
determine that a confidence score associated with the prediction is below a threshold, wherein the generating of the embedding, the selecting of the set of candidate labels, the selecting of the refined set of candidate labels, the providing of the natural language descriptions of the refined set of candidate labels and the input string to the language processing machine learning model, and the assigning of the label are based on the determining that the confidence score associated with the prediction is below the threshold.

20. A non-transitory computer readable medium comprising instructions that, when executed by one or more processors of a computing system, cause the computing system to:
generate, using a bidirectional encoder model, an embedding of an input string related to input data;
select a set of candidate labels from a plurality of labels based on the embedding;
select a refined set of candidate labels based on using a cross-encoder model to generate a respective joint embedding of the input string and each respective label in the set of candidate labels, wherein the refined set of candidate labels includes fewer than all labels in the set of candidate labels;
provide natural language descriptions of the refined set of candidate labels and the input string to a language processing machine learning model;
assign a label to the input data based on the language processing machine learning model outputting the label in response to the natural language descriptions of the refined set of candidate labels and the input string; and
perform an action based on the assigning of the label to the input data.
